(19) United States
(12) Patent Application Publication
(10) Pub. No.: US 2015/0143744 A1
(43) Pub. Date: May 28, 2015

(54) METHOD OF PRESERVING CUT FLOWERS

(71) Applicant: KELLY TOOKES, ENGLEWOOD, NJ (US)

(72) Inventor: KELLY TOOKES, ENGLEWOOD, NJ (US)

(21) Appl. No.: 14/088,240

(22) Filed: Nov. 22, 2013

(51) Int. Cl. A01G 5/06; A01G 5/04; A01N 3/00; A47G 7/00; A47G 7/03

(52) U.S. Cl. CPC A01G 5/06; A47G 7/00; A47G 7/03; A01N 3/00; A01G 5/04
USPC 47/41.13; 47/58.1 CF

(57) ABSTRACT

A method of preserving cut flowers includes the following steps. Provide a first material for forming a rigid, impermeable structure. Then define a hollow inner space by making a rigid, shaped, impermeable exoskeleton form defining a hollow inner space from the first material. Then fill the hollow inner space with a moisture retaining material. Finally, mount at least one flower stem through the rigid, shaped, impermeable exoskeleton. into the hollow inner space

### BACKGROUND OF THE INVENTION

Heretofore, cut flowers have been sustained by placing the stem(s) thereof in a package housing a moisture retaining medium in the form of gels or blocks of material. It has long been known to form a pervious exoskeleton package from which with moisture can evaporate and without a sealed means for preventing any material from spilling out of the package. The packaging employed has not been suitable for recycling which is an environmental and economic disadvantage since the use of such packages in the cut flower industry is widespread.

For example it is known that a topiary plant can be contained in moisture retaining medium such as moss with the moss suspended in an open framework of skeletal members from which moisture can escape readily.

A bouquet of cut flowers has been described as being packaged in a plastic film tube, open at a large end and sealed at an opposite smaller, bottom end. The plastic film tube comprises a thin fragile material. The tube has been filled through a flap in its side with a preservative gel. While the plastic film may be impervious, a disadvantage of plastic film is that the film is easily bent, is very flexible and has the environmental and economic problem that such material is not suitable for recycling. Another disadvantage is that such materials cannot be molded into a desired rigid shape. There is no suggestion that the film is rigid, that it is an exoskeleton or that it is adapted to be recycled.

Alternatively it has been suggested to provide a sheet of material constructed of a material selected from a group of materials consisting of paper, metal foil, cloth (natural or synthetic or combinations thereof), denim, burlap, or a polymer film. The sheet of material is not described to be rigid nor does it describe use of an exoskeleton. It has also been taught to provide a flower pot in an inner container which is pervious. The pot is within an impervious container with floral gel between the pot and the container. There is no suggestion of providing a rigid impervious package for the plant itself.

In accordance with this invention, a rigid, shaped, impermeable, exoskeleton package for cut flowers contains a moisture retaining medium required to sustain the vitality of the cut flowers. The advantage of use of the rigid, shaped, impermeable, exoskeleton package is that that it decouples the structural shape of the package from the configuration or shape. Preferably the exoskeleton is thin, rigid, and impermeable and is molded into a desired shape. For example the exoskeleton may have the shape of a high heeled shoe in the form of two halves (left & right) that are then bonded together at the time of use with an instantaneous adhesive. Preferably, the exoskeleton elements are composed of expanded polystyrene with a density driven by the size of the part or parts forming the exoskeleton. Alternatively the exoskeleton may comprise a metal framework encased in a rigid, shaped, impermeable packaging material.

Once assembled, the resulting rigid, shaped, hollow, impervious package is filled with a moisture retaining medium in the form of a porous block of moisture retaining material or with small particles of a moisture-retaining gel composed of an organic polymer known in the trade as a flower gel or a water gel. The small gel particles comprise gel pellets and beads composed of one of several hydrophilic organic polymers well known to those skilled in the art. These small hydrophilic gel pellets absorb water and swell to many times their original size. The impermeable exoskeleton prevents evaporation while the form is in use. Another advantage is that the gel composed of beads/pellets can be reused because after disassembly the gel are dried causing them to shrink to their original smaller size, making them suitable for storage. Some water gel is sold as beads that look very similar to glass beads.

While the exoskeleton may be filled with gel in the form of beads/pellets as an alternative the exoskeleton can be filled with shredded floral foam, there are several alternatives thereto. Several suitable alternative rigid, shaped, exoskeleton materials include molded pulps, mushroom packaging, palm fiber or Expandable PolyLactic Acid (PLA) foam also known as biofoam.

### BRIEF DESCRIPTION OF THE DRAWINGS

FIG. 1A shows a sequence of steps of forming a package for sustaining cut flowers including as step of insertion of the flowers into the package.

FIG. 1B, shows a sequence of steps of forming a package for sustaining cut flowers including as step of insertion of the flowers into the package method is shown which is an alternative to that of FIG. 1A.

FIG. 1C shows a sequence of steps for forming a package for sustaining cut flowers including as step of insertion of the flowers into the package method is shown which is another alternative to that of FIG. 1A.

FIG. 2A shows a more detailed method starts with STEP A, followed by new STEPS B2 B3, C, and D2.

FIG. 2B shows a more detailed method starts with STEP A, followed by new STEPS B2, B′, B3, and STEPS C and D2.

FIG. 3 shows an exploded view of a rigid, inner frame of an exoskeleton to be used in accordance with this invention.

FIG. 4 shows the rigid, inner frame of FIG. 3 assembled together.

FIG. 5 shows the rigid, inner frame of FIG. 4, with the frame bottom below and the back frame and the front frame upright with the handles juxtaposed near each other.

FIG. 6 shows a phantom view of the rigid, inner frame of FIG. 5 which is sealed inside an exoskeleton.

FIGS. 7A-7C are photographs illustrating an assembled transparent rigid, plastic exoskeleton. FIG. 7A shows the assembled exoskeleton. FIG. 7B shows a first half of the exoskeleton. FIG. 7C shows the second half of the exoskeleton. FIGS. 7D and 7E are additional e photographs of the first and second halves of the exoskeleton. FIG. 7F is a photograph of both halves of the exoskeleton.

FIG. 8 is a photograph of showing a perspective view of the assembled transparent rigid, plastic exoskeleton of FIG. 7A filled with shredded floral foam.

FIG. 9 is a photograph of showing an elevational view of the assembled transparent rigid, plastic exoskeleton of FIG. 7A filled with shredded floral foam.

### EMBODIMENTS OF THE INVENTION

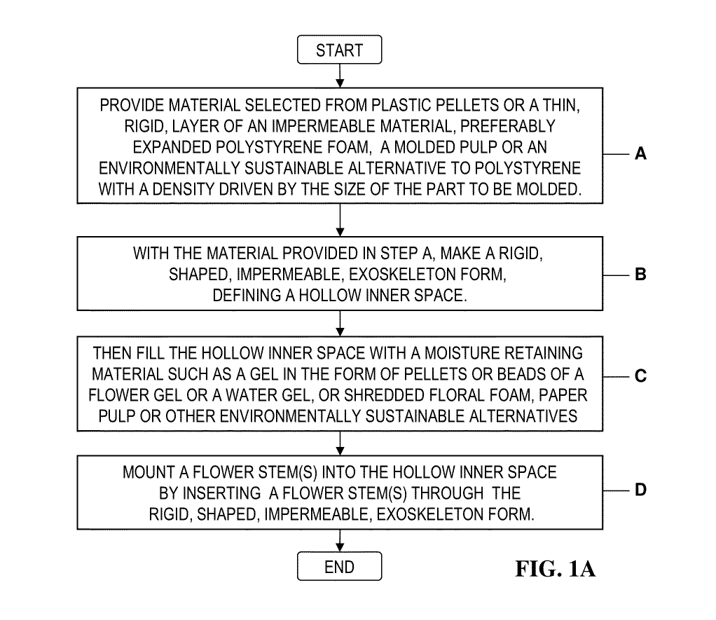

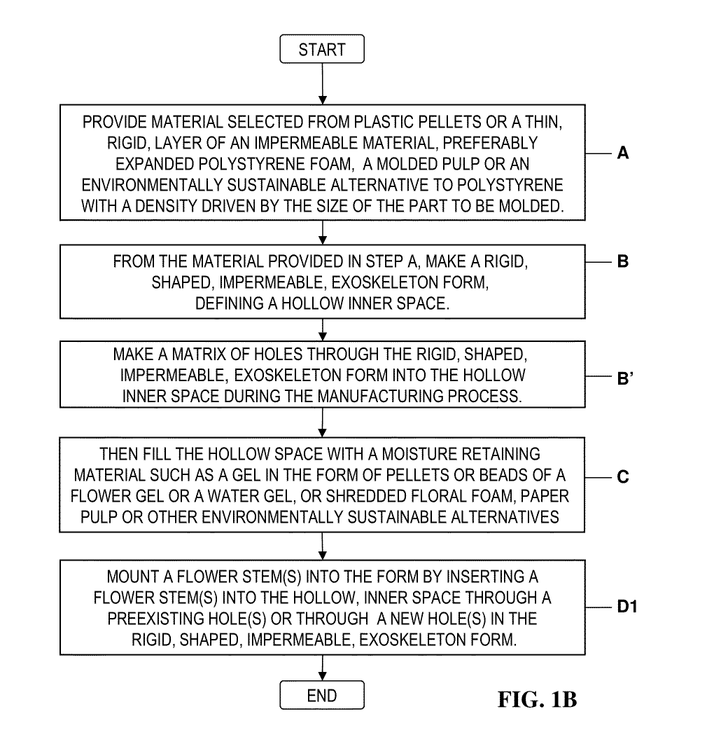

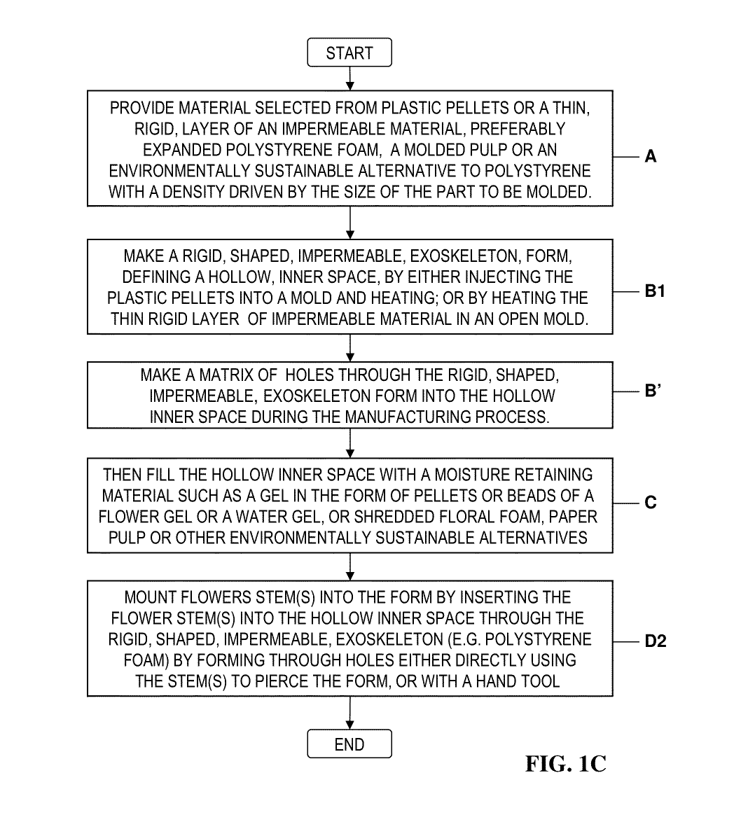

FIG. 1A shows a sequence of steps of forming a package for sustaining cut flowers including as step of insertion of the flowers into the package.

In FIG. 1A, the function performed in STEP A. is provision of plastic pellets or a thin, rigid, shaped, layer of an impermeable material, preferably expanded polystyrene foam, molded pulp or sustainable alternatives to polystyrene with a density driven by the size of the part to be molded. In STEP B, from the material provided make a rigid, shaped, impermeable exoskeleton form, defining a hollow inner space. Then, in STEP C, fill the hollow inner space with a moisture retaining material, i.e. which retains water, such as a gel in the form of pellets or beads of a flower gel or a water gel, or shredded floral foam, paper pulp or other environmentally sustainable alternatives. Finally in STEP D, which follows STEP C, mount flowers into the form by inserting the flower stem(s) into the inner space through the rigid, shaped, impermeable exoskeleton.

FIG. 1B, shows a sequence of steps of forming a package for sustaining cut flowers including as step of insertion of the flowers into the package method is shown which is an alternative to that of FIG. 1A. In FIG. 1B the method starts with previous STEPS A and B followed by new STEP B′, previous STEP C and new STEP D1. In STEP A. provide plastic pellets or a thin, rigid, layer of an impermeable material, preferably expanded polystyrene foam, molded pulp or sustainable alternatives to polystyrene with a density driven by the size of the part to be molded. In STEP B, from the material provided make a rigid, shaped, hollow, impermeable exoskeleton form, defining an inner space. In new STEP B′, make a matrix of holes through the rigid, shaped, impermeable exoskeleton into the hollow, inner space, during the manufacturing method. Then, in STEP C, fill the hollow inner space with a moisture retaining material, i.e. which retains water, such as a gel in the form of pellets or beads of a flower gel or a water gel, or shredded floral foam, paper pulp or other environmentally sustainable alternatives. Next in new STEP D1, mount flowers stem(s) into the form made in STEP B, by inserting the flower stem(s) into the inner space through preexisting holes or new holes formed in the exoskeleton either with a tool or with a flower stem. FIG. 1C shows a sequence of steps for forming a package for sustaining cut flowers including as step of insertion of the flowers into the package method is shown which is another alternative to that of FIG. 1A.

In FIG. 1C the method starts with previous STEP A followed by new STEP B1, STEPS B′, C and new STEP D2. In STEP A, provide plastic pellets or a thin, rigid, layer of an impermeable material, preferably expanded polystyrene foam, molded pulp or sustainable alternatives to polystyrene with a density driven by the size of the part to be molded. In STEP B1, make a rigid, shaped, exoskeleton form, defining an inner space, by either injecting the plastic pellets from STEP A into a mold and heating, or by heating the thin rigid, layer of impermeable material from STEP A in an open mold. In STEP B′, make a matrix of holes through the rigid, shaped impermeable exoskeleton into the hollow, inner space, during the manufacturing method. Then, in STEP C, fill the hollow inner space with a moisture retaining material, i.e. which retains water, such as a gel in the form of pellets or beads of a flower gel or a water gel, or shredded floral foam, paper pulp or other environmentally sustainable alternatives. Next in new STEP D2, mount flowers stem(s) into the form by inserting the flower stem(s) into the inner space through the exoskeleton. (e.g. polystyrene foam) forming through holes either directly using the stem to pierce the form, or with a hand tool.

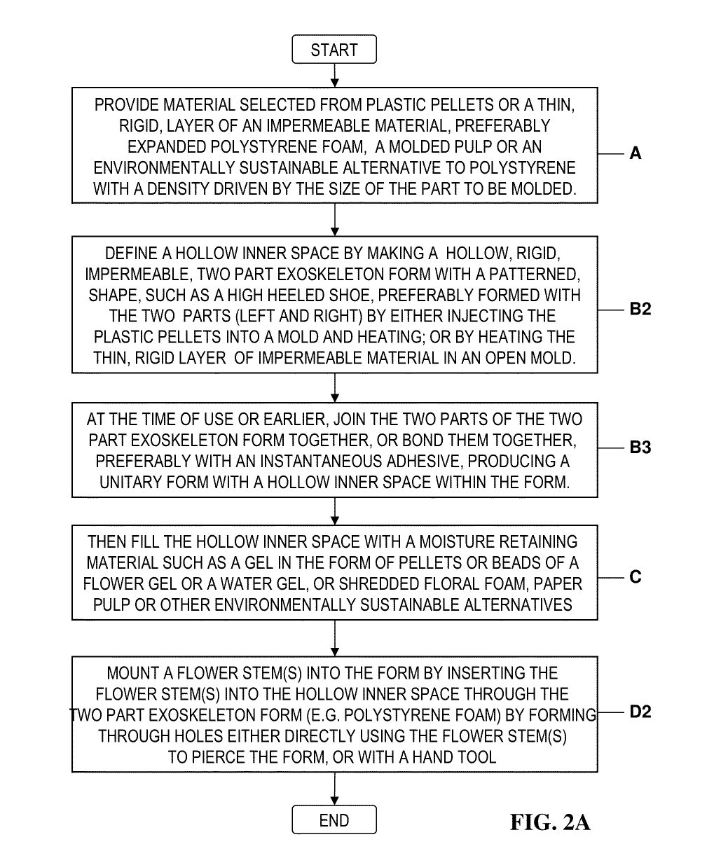

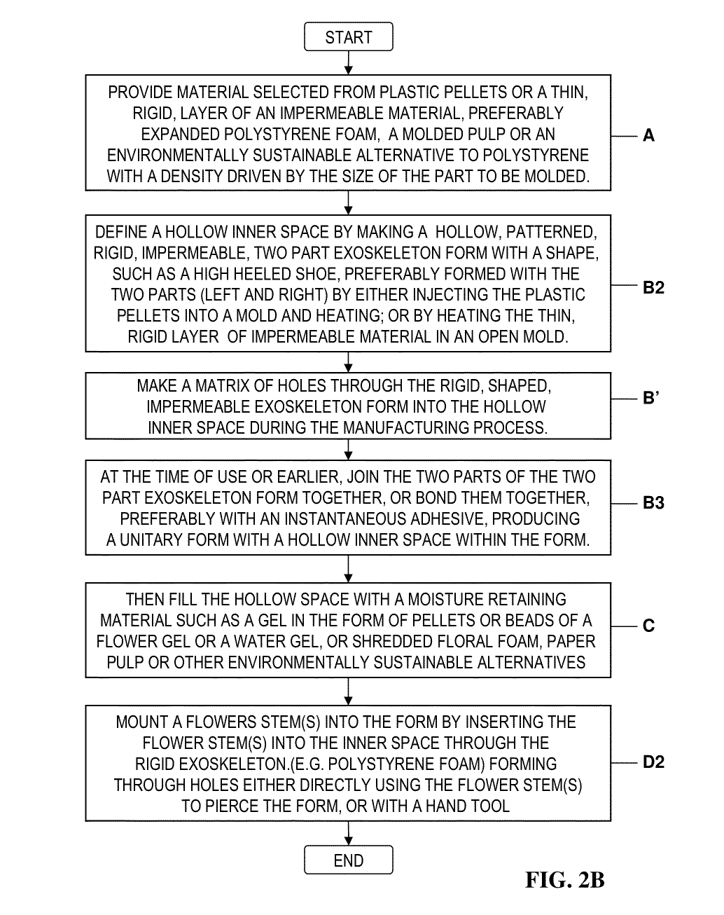

Referring to FIG. 2A, another, more detailed method starts with STEP A, followed by new STEPS B2 and B3, and STEPS C and D2. In STEP A of FIG. 2A, provide plastic pellets or a thin, rigid, layer of an impermeable material, preferably expanded polystyrene foam, molded pulp or sustainable alternatives to polystyrene with a density driven by the size of the part to be molded. In STEP B2, define an inner space by making a hollow, patterned, two part, exoskeleton form with a shape, such as a high heeled shoe, preferably formed with the two parts (left and right) by either injecting the plastic pellets from STEP A into a mold and heating; or by heating the thin, rigid layer of impermeable material from STEP A in an open mold. In STEP B3, at the time of use or earlier, join the two parts of the exoskeleton form together, or bond them together, preferably with an instantaneous adhesive, producing a form with a hollow inner space within the form. Then, in STEP C, fill the hollow inner space with a moisture retaining material, i.e. which retains water, such as a gel in the form of pellets or beads of a flower gel or a water gel, or shredded floral foam, paper pulp or other environmentally sustainable alternatives. Next in new STEP D2, mount flowers stem(s) into the form by inserting the flower stem(s) into the inner space through the exoskeleton. (e.g. polystyrene foam) forming through holes either directly using the stem to pierce the form, or with a hand tool.

Referring to FIG. 2B, which is a modification of FIG. 2A the method starts with STEP A, followed by STEPS B2, B′, B3, C, and D2. In STEP A, of FIG. 2B, provide plastic pellets or a thin, rigid, layer of an impermeable material, preferably expanded polystyrene foam, molded pulp or sustainable alternatives to polystyrene with a density driven by the size of the part to be molded. In STEP B2, define an inner space by making a hollow, patterned, two part, exoskeleton form with a shape, such as a high heeled shoe, preferably formed with the two parts (left and right) by either injecting the plastic pellets from STEP A into a mold and heating; or by heating the thin, rigid layer of impermeable material from STEP A in an open mold. In STEP B′, make a matrix of holes through the rigid, shaped, impermeable exoskeleton into the hollow inner space, during the manufacturing method. In STEP B3, at the time of use or earlier, join the two parts of the exoskeleton form together, or bond them together, preferably with an instantaneous adhesive, producing a form with a hollow inner space within the form. Then, in STEP C, fill the hollow inner space with a moisture retaining material, i.e. which retains water, such as a gel in the form of pellets or beads of a flower gel or a water gel, or shredded floral foam, paper pulp or other environmentally sustainable alternatives. Next in new STEP D2, mount flowers stem(s) into the form by inserting the flower stem(s) into the inner space through the exoskeleton. (e.g. polystyrene foam) forming through holes either directly using the stem to pierce the form, or with a hand tool.

### Embodiment of a Method of Forming an Exoskeleton

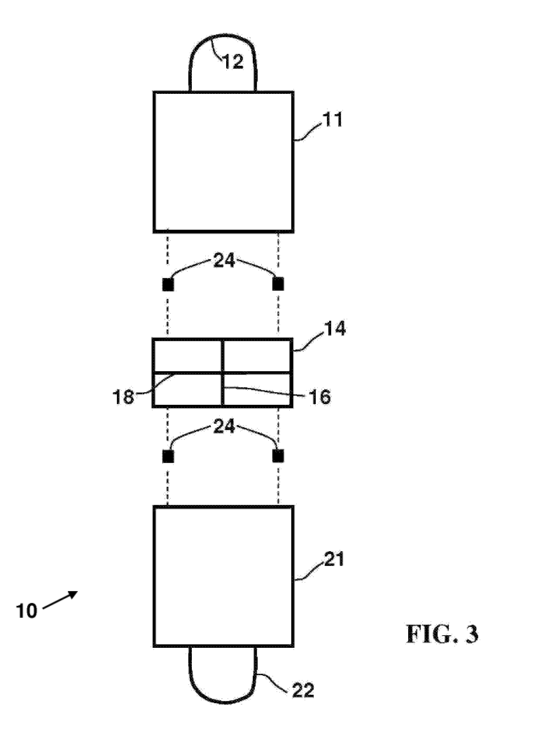

FIG. 3 shows an exploded view of a rigid, inner frame 10 of an exoskeleton to be used in accordance with this invention. The frame 10 is formed of a rigid material such as wire or a rigid, plastic material suitable for uses such as extruded rods or tubes composed of nylon or plastic materials selected from PolyPropylene (PP), PolyEthylene (PE), and Poly Viny Chloride (PVC). On top of FIG. 3 is a rectangular frame back 11 with a handle 12 secured thereto. The handle may be composed of the same material as the back 11 or a rope or similar material. Below the back is rectangular frame bottom 14 with right angle crossed stabilizers 16 and 18 secured to the opposite sides of frame bottom 14. The first pair of four frame fasteners 24 are shown between the frame back 11 and the frame bottom 14 which are used to secure those two elements of the inner frame 10 together. Below the frame bottom 14 and a frame front 21 is the other pair of frame fasteners 24. The rectangular frame front 21 has a handle 22 secured thereto.

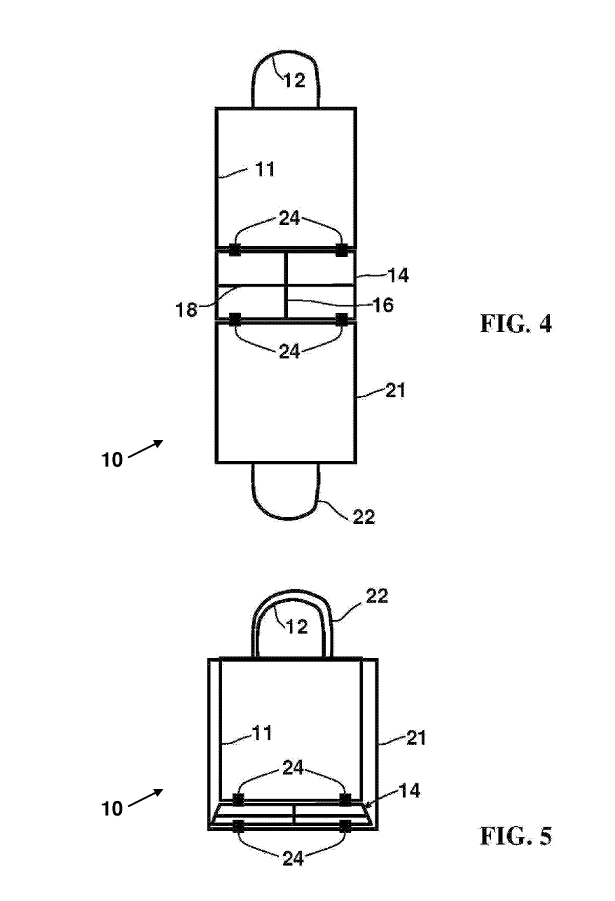

FIG. 4 shows the rigid, inner frame 10 assembled by securing the frame fasteners 24 to opposite sides of the frame bottom 14 and to the back frame 11 and the front frame 21.

FIG. 5 shows the rigid, inner frame 10 of FIG. 4 with the frame bottom 14 below and the back frame 11 and the front frame 21 upright with the handles 12 and 22 juxtaposed near each other.

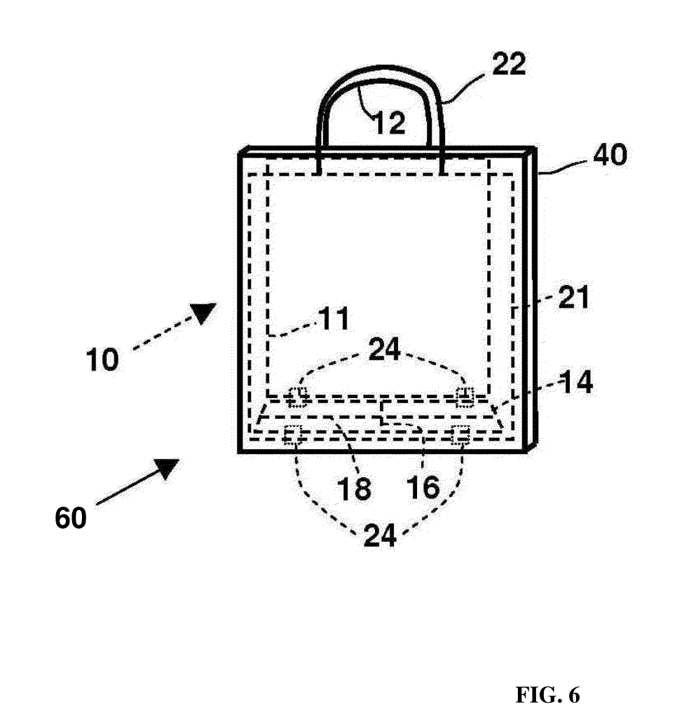

FIG. 6 shows a phantom view of the rigid, inner frame 10 of FIG. 5 which is sealed inside an exoskeleton 60 comprising an impermeable durable, thick, rigid skin 40. The impermeable durable, thick, rigid skin 40 may comprise a rigid, impervious, reusable plastic container which is secured to the rigid, inner fame 11 by tabs (not shown) or by packaging or shipping tape.

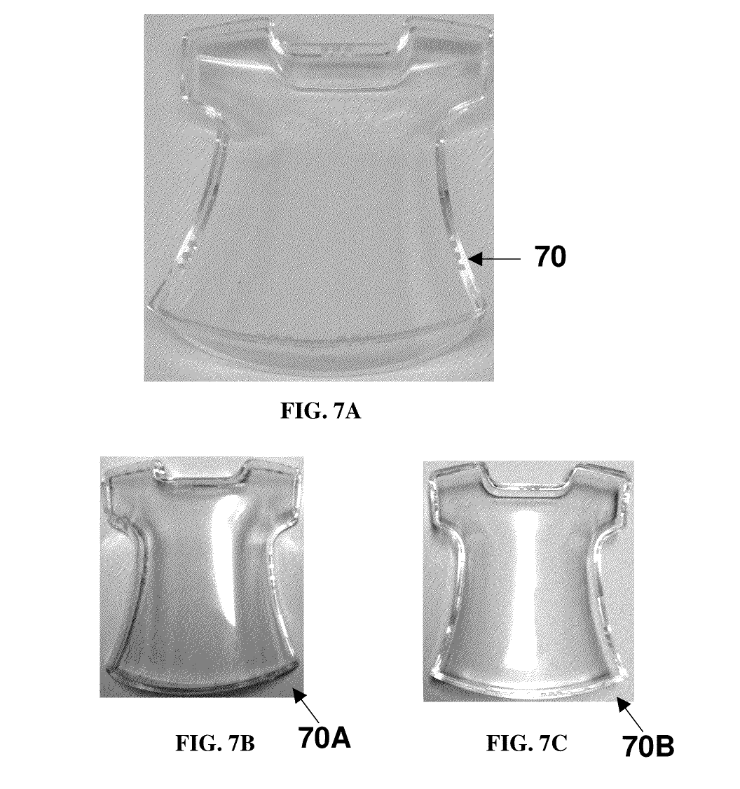

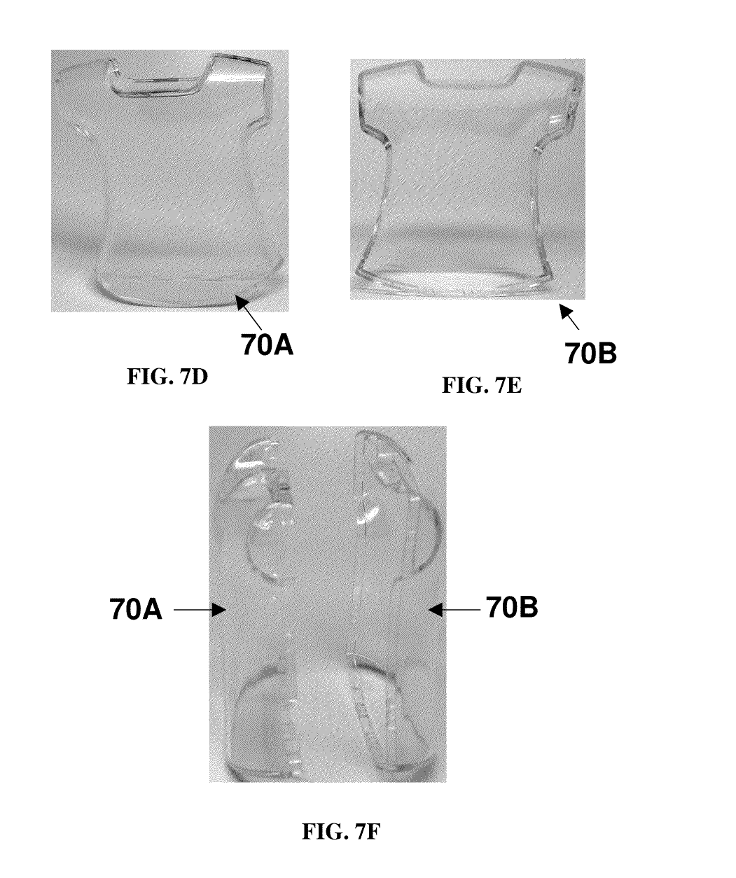

FIGS. 7A-7C are photographs illustrating an assembled transparent rigid, plastic exoskeleton 70 and components 70A and 70B thereof. The exoskeleton 70 has been kind formed in accordance with steps B2 and B3 of FIGS. 2A and 2B as described above. FIG. 7A shows the assembled exoskeleton 70. FIG. 7B shows a first half 70A of the exoskeleton 70, and FIG. 7C shows the second half 70B thereof, FIGS. 7D, 7E, and 7F show more photographs of the halves 70A and 70B of the exoskeleton 70. FIGS. 7D and 7E are separate photographs of the first half 70A and the second half 70B of the exoskeleton. FIG. 7F is a photograph of both halves 70A and 70B of the exoskeleton 70.

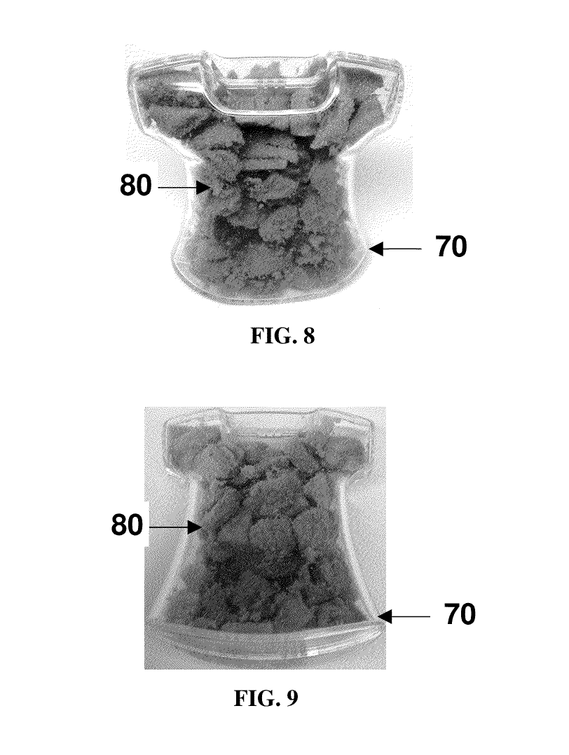

FIG. 8 is a photograph of showing a perspective view of the assembled transparent rigid, plastic exoskeleton 70 of FIG. 7A filled with shredded Oasis® floral foam 80.

FIG. 9 is a photograph of showing an elevational view of the assembled transparent rigid, plastic exoskeleton 70 of FIG. 7A filled with shredded Oasis® floral foam 80.

Alternative Materials

Molded-pulps also known as molded pulp or molded fiber are packaging materials, typically made from recycled paperboard, newsprint or other organic material, such as compressed sphagnum moss or compressed peat humus. Uses for molded pulps include protective packaging or for food service trays and beverage carriers, end caps, trays, plates, bowls and clamshell containers. For many applications, molded pulp is less expensive than expanded polystyrene (EPS), vacuumed formed PET and PVC, corrugation, and foams. Molded pulp is produced from recycled materials, and can be recycled again after its useful life-cycle. It is well known that molded pulp products can be made waterproof with a spray or dip coating of a moisture sealant such as wax. See http://www.molded-pulp.com where the product is available.

Mushroom packaging is composed of mycelium fibers which are the vegetative part of a fungus, consisting of a mass of branching, threadlike hyphae which are the long, branching filamentous structure of a fungus. The mycelium is bonded with chitin. Chitin (C8H13O5N)n is a long-chain polymer of N-acetylglucosamine, a derivative of glucose. It is the main component of the cell walls of fungi, the exoskeletons of arthropods such as crustaceans (e.g., crabs, lobsters and shrimps) and insects, the radulas of mollusks, and the beaks and internal shells of cephalopods, including squid and octopuses. In terms of structure, chitin may be compared to the polysaccharide cellulose and, exist in nature in the form of nanocrystallites named nanofibrils or whiskers. In terms of function, chitin may be compared to the protein keratin. Mycelium is a natural, self-assembling, glue that can digest crop waste to produce packaging materials. The mycelium can fuse agricultural waste such as seed husks into solid forms. See http://www.ecovativedesign.com/products-and-applications/packaging/ and patents and Ford Global Technologies, Inc. and patent applications of Rocco, Charles Alan, Kalisz, Raymond Edward and their coinventors.

Palm fiber: http://earthcycle.com/products/index.html. Palm fiber (aka Oil palm fiber) is a natural, renewable resource extracted from the palm husk once it has become an empty fruit bunch (EFP)—in other words, once the fruits have been harvested from the oil palm for oil production. The fiber can be used as mulch, fertilizer or soil remediation, or it can be processed and refined for the manufacturing of mattresses, sofas, and car seats for example. Newer applications make use of the fiber's natural water repellent properties to form palm pulp for molded packaging and paper materials. Research has shown that the fiber has nutritional and health benefits. Application of the fiber for foods such as cereals has now been recorded as well. According to several sources that use palm fiber for the manufacturing of their products, processing generally does not require any chemicals, as such, the palm fiber remains natural, clean and non-toxic.

Expandable Polylactic acid (PLA) and PS and PLA Compounds available from among other sources the firm of Synbra Technology by located in Etten-Leur, The Netherlands. PLA compounds are produced from the renewable resource PLA (PolyLactic Acid or PolyLActide. PLA is a foam product with a different environmental profile from traditional oil based plastics. After use, the PLA product can be remolded into a new product like EPS and it has additional end of life options. It can be completely biodegraded, composted or used for feedstock for recycling. Being ‘designed for the environment’ implies there is no chemical waste. (PLA) is a thermoplastic aliphatic polyester derived from renewable resources, such as corn starch (in the United States), tapioca roots, chips or starch (mostly in Asia), or sugarcane (in the rest of the world. PLA is a biodegradable thermoplastic derived from lactic acid which resembles clear polystyrene, provides good aesthetics (gloss and clarity). PLA is stiff and brittle and needs modifications for most practical applications (i.e. plasticizers to increase its flexibility). It can be processed like most thermoplastics into fibers, films, thermoformed or injection molded. Among other things, it is used for plant pots and packaging. (See http://www.synbratechnology.nl/) See U.S. Pat. No. 8,283,389 B2 of Witt al for “Methods of Manufacture of Polylactic Acid Foams

As described above, the final step of the method of the present invention is to mount the cut flowers with their cut stem(s) in direct contact with the moisture retaining medium in the interior space within the impervious exoskeleton with the stem(s) of the flowers in direct contact with the moisture retaining medium housed in the interior space. A preferred method of insertion of the stem(s) into the interior space involves inserting the cut flower stem(s) through polystyrene foam either directly using the stem to pierce the foam or with a simple hand tool. Alternatively a matrix of holes can be molded into the exoskeleton at the time of manufacture. Ultimately the insertion method will be determined by production costs and the exoskeleton materials employed.

This approach has the following advantages described next. First, the exoskeleton embodiment decouples the material used for the structure from the moisture retention floral material. The advantage is that since two functions have largely incompatible requirements, this embodiment allows all of the requirements to be satisfied. Second, the exoskeleton has the structural rigidity needed for large sculptures, whereas, floral foam does not. The exoskeleton can be molded from material such as polystyrene which is extremely inexpensive and virtually every molder is comfortable using this material, e.g., it is used as packaging material for most electronic products. Few molders will mold floral foam particularly given the low volume anticipated, low thousands per year versus tens of thousands per month for polystyrene packaging. Accordingly it has been found to be wise to use materials that are already used in injection machines employed by suppliers of the polystyrene materials. In addition, the impervious exoskeleton is provided to prevent moisture loss from the floral medium thus providing the fresh flowers with a source of water that will not dry out during the floral presentation period. Like the floral foam an impervious polystyrene foam exoskeleton allows for ease of flower stem insertion and support of the flower stem(s).

While the primary description of the method of preserving cut flowers has been directed to floral arrangements, it will be seen that no limitations have been placed upon the sizes or dimensions. The foregoing description discloses only exemplary embodiments of the invention. Modifications of the above disclosed methods and apparatus that fall within the scope of the invention will be readily apparent to those of ordinary skill in the art. While this invention is described in terms of the above specific exemplary embodiment(s), those skilled in the art will recognize that the invention can be practiced with modifications within the spirit and scope of the appended claims, i.e. changes can be made in form and detail, without departing from the spirit and scope of the invention. In summary, it should be understood that changes can be made to provide other embodiments that may fall within the spirit and scope of the invention and all such changes come within the purview of the present invention and the invention encompasses the subject matter defined by the following claims. In other words, it is to be understood that the present invention is not limited to the embodiments described above, but encompasses any and all embodiments within the scope of the following claims.

What is claimed is:

1. A method of preserving cut flowers by the steps comprising:
A. providing a first material for forming a rigid, impermeable structure;
B. then defining a hollow inner space by making a rigid, shaped, impermeable exoskeleton form defining a hollow inner space from the first material;
C. then filling the hollow inner space with a moisture retaining material; and
D. then mounting at least one flower stem through the rigid, shaped, impermeable exoskeleton into the hollow inner space.

2. The method of claim 1 wherein the first material is selected from the group consisting essentially of plastic pellets or a thin, rigid, layer of an impermeable material such as expanded polystyrene foam, or a molded pulp or an environmentally sustainable material with a density driven by the size of the part to be molded.

3. The method of claim 1 wherein the moisture retaining material is selected from the group consisting essentially of a gel in the form of pellets or beads of a flower gel or a water gel, or shredded floral foam, paper pulp or an environmentally sustainable alternative.

4. The method of claim 2 wherein the moisture retaining material is selected from the group consisting essentially of a gel in the form of pellets or beads of a flower gel or a water gel, or shredded floral foam, paper pulp or an environmentally sustainable alternative.

5. The method of claim 3 wherein the moisture retaining material is selected from the group consisting essentially of a gel in the form of pellets or beads of a flower gel or a water gel, or shredded floral foam, paper pulp or an environmentally sustainable alternative.

6. The method of claim 1 including performing a step after step B comprising:
making a matrix of holes through the rigid, shaped, impermeable exoskeleton into the hollow inner space during the manufacturing method.

7. The method of claim 6 wherein the first material is selected from the group consisting essentially of plastic pellets or a thin, rigid, layer of an impermeable material such as expanded polystyrene foam, or a molded pulp or an environmentally sustainable material with a density driven by the size of the part to be molded.

8. The method of claim 7 wherein the moisture retaining material is selected from the group consisting essentially of a gel in the form of pellets or beads of a flower gel or a water gel, or shredded floral foam, paper pulp or an environmentally sustainable alternative.

9. The method of claim 8 wherein the moisture retaining material is selected from the group consisting essentially of a gel in the form of pellets or beads of a flower gel or a water gel, or shredded floral foam, paper pulp or an environmentally sustainable alternative.

10. The method of claim 1 wherein the impermeable exoskeleton is formed by either injecting plastic pellets into a mold and heating or by heating a thin layer of impermeable material in an open mold.

11. The method of claim 10 wherein the first material is selected from the group consisting essentially of plastic pellets or a thin, rigid, layer of an impermeable material such as expanded polystyrene foam, or a molded pulp or an environmentally sustainable material with a density driven by the size of the part to be molded.

12. The method of claim 1 wherein the step of mounting at least on flower stem into the hollow inner space through the exoskeleton is performed by inserting the at least on flower stem into the hollow inner space through the exoskeleton forming through holes either directly using the stem to pierce the form, or piercing the exoskeleton with a hand tool.

13. The method of claim 1 wherein the step of defining the hollow inner space is performed by the steps comprising:
making a rigid, shaped, hollow, impermeable exoskeleton form from the first material by making a hollow, patterned, multiple part, exoskeleton form with a shape, comprising at least two parts by either injecting plastic pellets into a mold and heating; or by heating a thin, rigid layer of impermeable material in an open mold; and
then followed by joining the parts of the exoskeleton form together, or bonding the parts together, producing the form with the hollow inner space therein.

14. The method of claim 13 wherein the step of mounting flower is performed by inserting the at least on flower stem into the hollow inner space through the impermeable exoskeleton forming through holes either directly using the stem to pierce the form, or with a hand tool.

15. The method of claim 13 wherein the impermeable exoskeleton is composed of polystyrene foam.

16. The method of claim 1 wherein the impermeable exoskeleton is formed with a rigid frame surrounded by an impermeable material.

17. Apparatus for preserving cut flowers comprising:
a rigid, shaped, impermeable exoskeleton form composed of a first material defining a hollow inner space,
the hollow inner space being filled with a moisture retaining material; and
at least one flower stem hole being provided through the rigid, shaped, impermeable exoskeleton into the hollow inner space;
whereby a flower stem can be mounted in the flower stem hole reaching into the hollow inner space.

18. The apparatus of claim 17 wherein the first material is selected from the group consisting essentially of plastic pellets or a thin, rigid, layer of an impermeable material such as expanded polystyrene foam, or a molded pulp or an environmentally sustainable material with a density driven by the size of the part to be molded.

19. The apparatus of claim 17 wherein the moisture retaining material is selected from the group consisting essentially of a gel in the form of pellets or beads of a flower gel or a water gel, or shredded floral foam, paper pulp or an environmentally sustainable alternative.

20. The apparatus of claim 1 wherein a matrix of flower stems holes is provided through the rigid, shaped, impermeable exoskeleton into the hollow inner space.
